(19) United States
(12) Patent Application Publication
(10) Pub. No.: US 2023/0187723 A1
(43) Pub. Date: Jun. 15, 2023

(54) BATTERY ARRAY DESIGNS WITH MULTIPLE COOLING SIDE CAPABILITIES FOR TRACTION BATTERY PACKS

(71) Applicant: FORD GLOBAL TECHNOLOGIES, LLC, Dearborn, MI (US)

(72) Inventors: Nihar KOTAK, Farmington Hills, MI (US); Francisco FERNANDEZ-GALINDO, Canton, MI (US); Daniel Paul ROBERTS, Livonia, MI (US)

(21) Appl. No.: 17/547,373

(22) Filed: Dec. 10, 2021

(51) Int. Cl. H01M 10/625; H01M 50/204; H01M 10/613; H01M 10/6554

(52) U.S. Cl. CPC H01M 10/625; H01M 10/613; H01M 10/6554; H01M 50/204; H01M 2220/20

(57) ABSTRACT

Battery array designs for electrified vehicle battery packs may include a thermal interface material disposed between battery cells of the array and both a top plate and a bottom plate of an array support structure. The battery array may therefore be configured to transfer heat through the top, bottom, or both. The battery array may further include a mounting flange located an equal distance from both the top plate and the bottom plate along a side plate of the array support structure. The battery array therefore provides a symmetrical design that simplifies assembly.

### TECHNICAL FIELD

This disclosure relates to traction battery packs, and more particularly to battery arrays that include features for dissipating heat from multiple sides of the battery array.

### BACKGROUND

Electrified vehicles can reduce or completely eliminate reliance on internal combustion engines. In general, electrified vehicles differ from conventional motor vehicles because they are selectively driven by one or more battery powered electric machines. Conventional motor vehicles, by contrast, rely exclusively on the internal combustion engine to propel the vehicle.

A high voltage traction battery pack typically powers the electric machines and other electrical loads of the electrified vehicle. An enclosure assembly of the battery pack houses a plurality of battery internal components including, but not limited to, battery arrays and other battery electronic components. The battery internal components typically must be retained from movement inside the enclosure assembly.

### SUMMARY

A battery array for a traction battery pack according to an exemplary aspect of the present disclosure includes, among other things, a top plate, a bottom plate, a battery cell arranged between the top plate and the bottom plate, a first thermal interface material disposed between the top plate and the battery cell, and a second thermal interface material disposed between the bottom plate and the battery cell.

In a further non-limiting embodiment of the foregoing battery array, a side plate is connected to both the top plate and the bottom plate.

In a further non-limiting embodiment of either of the foregoing battery arrays, the side plate includes a mounting flange that is spaced at about an equal distance from both the top plate and the bottom plate.

In a further non-limiting embodiment of any of the foregoing battery arrays, the battery array is secured to a support structure via the mounting flange.

In a further non-limiting embodiment of any of the foregoing battery arrays, the support structure is a cross-member bracket of the traction battery pack.

In a further non-limiting embodiment of any of the foregoing battery arrays, a heat exchanger plate is positioned atop the top plate.

In a further non-limiting embodiment of any of the foregoing battery arrays, a third thermal interface material is disposed between the heat exchanger plate and the top plate.

In a further non-limiting embodiment of any of the foregoing battery arrays, a heat exchanger plate is positioned beneath the bottom plate.

In a further non-limiting embodiment of any of the foregoing battery arrays, a third thermal interface material is disposed between the heat exchanger plate and the bottom plate.

In a further non-limiting embodiment of any of the foregoing battery arrays, a first heat exchanger plate is positioned atop the top plate, and a second heat exchanger plate is positioned beneath the bottom plate.

In a further non-limiting embodiment of any of the foregoing battery arrays, a third thermal interface material is disposed between the first heat exchanger plate and the top plate, and a fourth thermal interface material is disposed between the second heat exchanger plate and the bottom plate.

In a further non-limiting embodiment of any of the foregoing battery arrays, a second battery array is positioned over top of the top plate to establish a multi-tier configuration. A heat exchanger plate is disposed between the top plate of the battery array and a second bottom plate of the second battery array.

In a further non-limiting embodiment of any of the foregoing battery arrays, the battery cell includes a bent fold disposed between the top plate or the bottom plate and a surface of the battery cell, and a thermal adhesive is disposed between the bent fold and the surface.

In a further non-limiting embodiment of any of the foregoing battery arrays, the battery cell includes a fold accommodated within a relief opening of the top plate or the bottom plate.

In a further non-limiting embodiment of any of the foregoing battery arrays, the top plate or the bottom plate includes a plurality of fill ports.

A battery array for a traction battery pack according to another exemplary aspect of the present disclosure includes, among other things, a grouping of battery cells, a support structure arranged around an outer perimeter of the grouping of battery cells and including a pair of end plates, a pair of side plates, a top plate, and a bottom plate. Each side plate of the pair of side plates includes a mounting flange that is located at about an equal distance from both the top plate and the bottom plate. A first thermal interface material is disposed between the top plate and the grouping of battery cells, and a second thermal interface material is disposed between the bottom plate and the grouping of battery cells.

In a further non-limiting embodiment of the foregoing battery array, the first and second thermal interface materials are applied internally of the support structure.

In a further non-limiting embodiment of either of the foregoing battery arrays, the mounting flange is secured to a support structure of the traction battery pack.

In a further non-limiting embodiment of any of the foregoing battery arrays, a heat exchanger plate is positioned over the top plate or beneath the bottom plate.

In a further non-limiting embodiment of any of the foregoing battery arrays, a first heat exchanger plate is positioned over the top plate, and a second heat exchanger plate is positioned beneath the bottom plate.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 is a perspective view of a battery array of a traction battery pack.

FIG. 3 is an end view of the battery array of FIG. 2.

FIG. 4 is a cross-sectional view through section 4-4 of FIG. 2.

FIG. 5 illustrates an exemplary mounting configuration of the battery array of FIGS. 2-4.

FIG. 6 illustrates another exemplary mounting configuration of the battery array of FIGS. 2-4.

FIG. 7 illustrates an exemplary cooling configuration of a battery array.

FIG. 8 illustrates another exemplary cooling configuration of a battery array.

FIG. 9 illustrates yet another exemplary cooling configuration of a battery array.

FIG. 10 illustrates a multi-tier configuration of a traction battery pack.

FIG. 11 illustrates select portions of an exemplary battery array.

FIG. 12 illustrates select portions of another exemplary battery array.

FIG. 13 illustrates select portions of yet another exemplary battery array.

### DETAILED DESCRIPTION

This disclosure details battery array designs for electrified vehicle battery packs. An exemplary battery array may include a thermal interface material disposed between battery cells of the array and both a top plate and a bottom plate of an array support structure. The battery array may therefore be configured to transfer heat through the top, bottom, or both. The battery array may further include a mounting flange located an equal distance from both the top plate and the bottom plate along a side plate of the array support structure. The battery array therefore provides a symmetrical design that simplifies assembly. These and other features are discussed in greater detail in the following paragraphs of this detailed description.

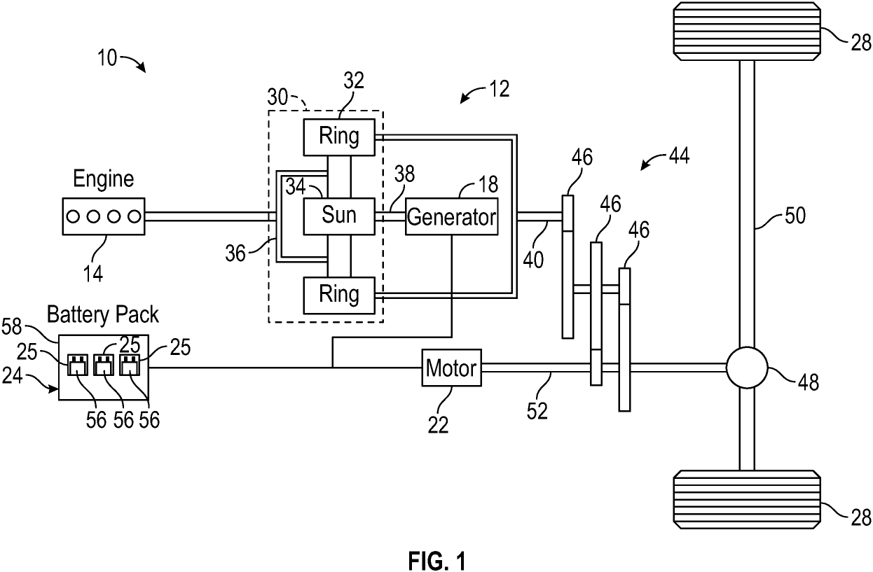

FIG. 1 schematically illustrates a powertrain 10 for an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEV’s), battery electric vehicles (BEVs), fuel cell vehicles, etc.

In an embodiment, the powertrain 10 is a power-split powertrain system that employs first and second drive systems. The first drive system includes a combination of an engine 14 and a generator 18 (i.e., a first electric machine). The second drive system includes at least a motor 22 (i.e., a second electric machine), the generator 18, and a traction battery pack 24. In this example, the second drive system is considered an electric drive system of the powertrain 10. The first and second drive systems are each capable of generating torque to drive one or more sets of vehicle drive wheels 28 of the electrified vehicle 12. Although a power-split configuration is depicted in FIG. 1, this disclosure extends to any hybrid or electric vehicle including but not limited to full hybrids, parallel hybrids, series hybrids, mild hybrids, or micro hybrids.

The engine 14, which may be an internal combustion engine, and the generator 18 may be connected through a power transfer unit 30, such as a planetary gear set. Of course, other types of power transfer units, including other gear sets and transmissions, may be used to connect the engine 14 to the generator 18. In an embodiment, the power transfer unit 30 is a planetary gear set that includes a ring gear 32, a sun gear 34, and a carrier assembly 36.

The generator 18 may be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In an embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In a non-limiting embodiment, the motor 22 and the generator 18 cooperate as part of a regenerative braking system in which both the motor 22 and the generator 18 can be employed as motors to output torque. For example, the motor 22 and the generator 18 can each output electrical power to the traction battery pack 24.

The traction battery pack 24 is an exemplary electrified vehicle traction battery. The traction battery pack 24 may be a high voltage traction battery pack that includes one or more battery arrays 25 (i.e., battery assemblies or groupings of battery cells 56) capable of outputting electrical power to operate the motor 22, the generator 18, and/or other electrical loads of the electrified vehicle 12 for providing power to propel the wheels 28. Other types of energy storage devices and/or output devices could also be used to electrically power the electrified vehicle 12.

The total number of battery arrays 25 and battery cells 56 provided within the traction battery pack 24 is not intended to limit this disclosure. In an embodiment, the battery cells 56 of each battery array 25 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 25 and any other battery internal components (e.g., battery electronics, wiring, connectors, etc.) of the traction battery pack 24 may be housed inside an enclosure assembly 58. In an embodiment, the enclosure assembly 58 is a sealed enclosure. The enclosure assembly 58 may include any size, shape, and configuration within the scope of this disclosure.

Assembling the traction battery pack 24 can be a relatively complicated task due to tolerance stack up and other manufacturing complexities. Moreover, the battery arrays 25 typically must be mounted in a specific configuration for achieving adequate battery cell cooling, which may further complicate assembly and limit flexibility in mounting the arrays in configurations that could potentially increase the energy density of the traction battery pack. This disclosure is therefore directed to improved battery array configurations that provide greater assembly flexibility and allow for the battery array to be cooled from multiple sides.

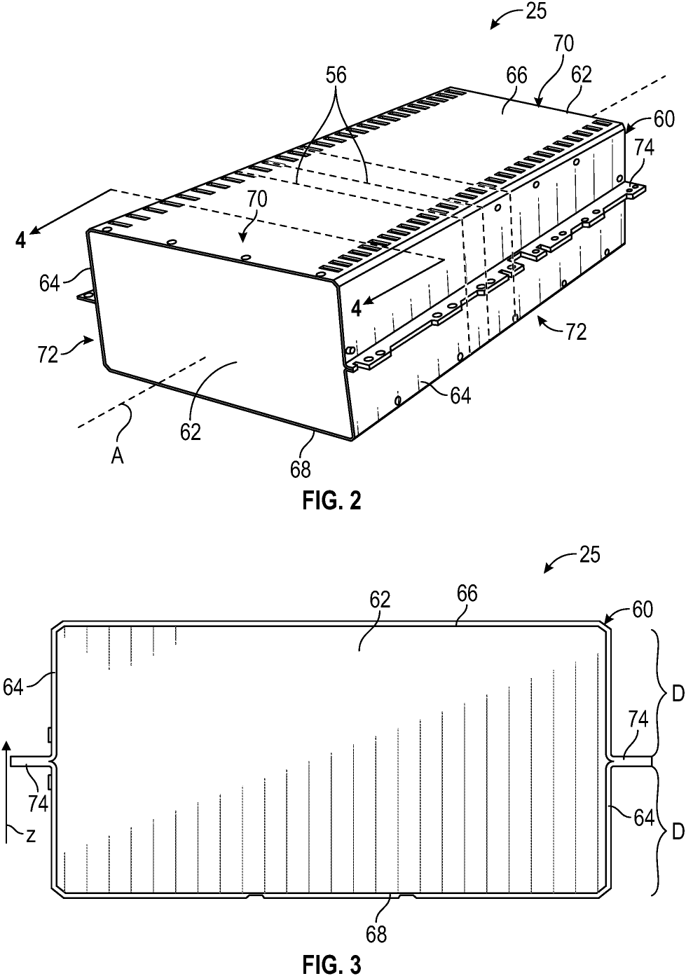

FIGS. 2, 3, and 4 illustrate an exemplary battery array 25 that can be employed within a traction battery pack of an electrified vehicle. For example, the battery array 25 could be employed for use within the traction battery pack 24 of the electrified vehicle 12 of FIG. 1 or any other electrified vehicle.

The battery array 25 may include a plurality of battery cells 56 that store energy for powering various electrical loads of the electrified vehicle 12. The battery array 25 could include any number of battery cells 56 within the scope of this disclosure. Accordingly, this disclosure is not limited to the exact configuration shown in FIGS. 2, 3, and 4.

The battery cells 56 may be stacked side-by-side along a stack axis to construct a grouping of battery cells 56, sometimes referred to as a “cell stack.” The grouping of battery cells 56 may be substantially surrounded by a support structure 60. The support structure 60 may be disposed about an outer perimeter of the cell stack for axially constraining the battery cells 56 in the stacked configuration.

In an embodiment, the support structure 60 of the battery array 25 includes pairs of end plates 62, a pair of side plates 64, a top plate 66, and a bottom plate 68. One end plate 62 may be disposed at each longitudinal extent 70 of the battery array 25, and one side plate 64 may connect between the end plates 62 on each side 72 of the battery array 25. The top plate 66 may connect between the end plates 62 and the side plates 64 and extend over top of the battery cells 56 of the cell stack, and the bottom plate 68 may connect between the end plates 62 and the side plates 64 and extend beneath the battery cells 56 of the cell stack. In a normal orientation of the battery array 25, the bottom plate 68 may establish a base of the cell stack.

The end plates 62 may extend within planes that are transverse to a longitudinal axis A of the battery array 25, and the side plates 64 may extend in planes that are parallel to the longitudinal axis A. In an embodiment, the longitudinal axis A may extend in a cross-car direction when the traction battery pack 24 is mounted on the electrified vehicle 12. However, other configurations and orientations of the battery array 25 when mounted on the electrified vehicle 12 are further contemplated within the scope of this disclosure.

Each side plate 64 of the support structure 60 may include a mounting flange 74 that protrudes laterally outward from a body of the side plate 64 in a direction away from the opposite side plate 64. In an embodiment, each mounting flange 74 is centered evenly at about a midspan location (along a vertical Z-axis direction of the battery array 25 as shown in FIG. 3) of its respective side plate 64. In this disclosure, the term “about” means that the expressed quantities or ranges need not be exact but may be approximated and/or larger or smaller, reflecting acceptable tolerances, conversion factors, measurement error, etc. Each mounting flange 74 may therefore be located an equal distance D (see FIG. 3) from both the top plate 66 and the bottom plate 68 of the support structure 60. In other embodiments, the mounting flange 74 may be slightly offset either toward the top plate 66 or toward the bottom plate 68.

The vertical Z-axis, for purposes of this disclosure, is with reference to ground and an ordinary orientation of the traction battery pack 24 during operation of the electrified vehicle 12 having the powertrain 10.

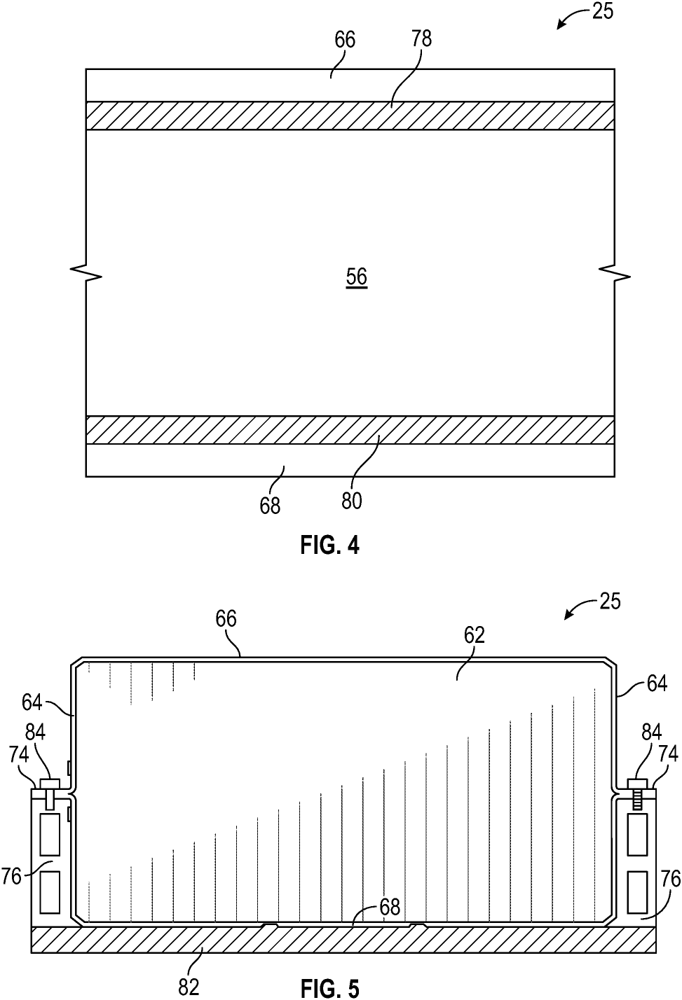

Referring now primarily to the cross-sectional view of FIG. 4, the battery array 25 may include a first thermal interface material 78 and a second thermal interface material 80. The first and second thermal interface material 78, 80 are shown schematically but could be first and second amounts of a thermal interface material that are applied internally (e.g., within the support structure 60). The first thermal interface material 78 may be disposed between the top plate 66 and the battery cells 56, and the second thermal interface material 80 may be disposed between the bottom plate 68 and the battery cells 56. Top and bottom surfaces of the battery cells 56 may thus be in direct contact with the first thermal interface material 78 and the second thermal interface material 80, respectively. The first thermal interface material 78 and the second thermal interface material 80 are adapted to maintain sufficient thermal contact between the battery cells 56 and the top plate 66 and the bottom plate 68, respectively, for increasing the thermal conductivity between these neighboring components during heat transfer events.

In an embodiment, the first and second thermal interface materials 78, 80 include an epoxy resin. In another embodiment, the first and second thermal interface materials 78, 80 include a silicone-based material. Other materials, including thermal greases, for example, may alternatively or additionally be utilized as the first and second thermal interface materials 78, 80.

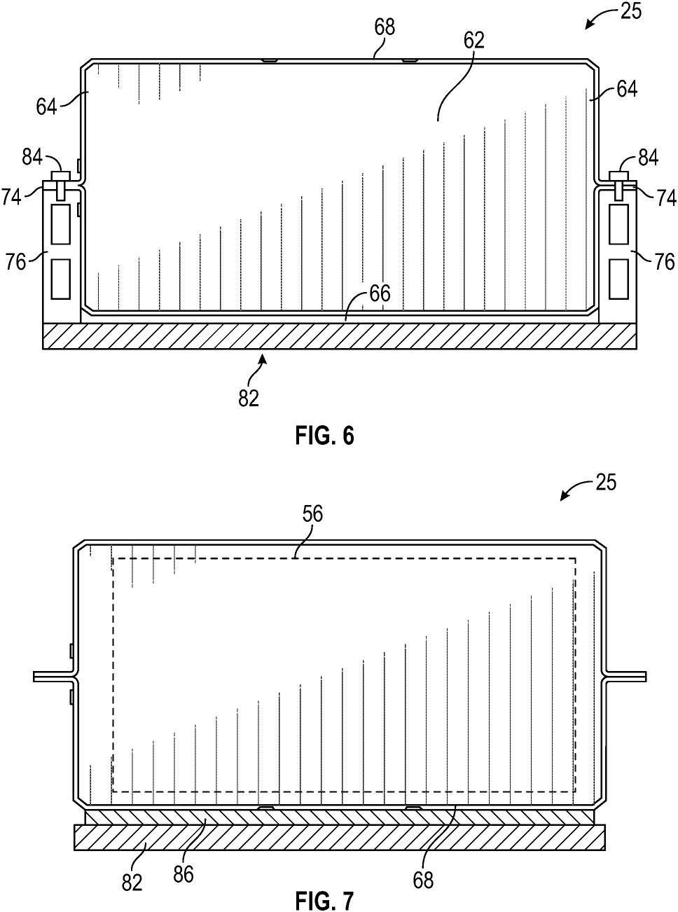

By centering the mounting flanges 74 on the side plates 64 and providing the thermal interface materials 78, 80 at the top and bottom of the battery array 25, the battery array 25 may provide a symmetrical configuration in which either the top plate 66 or the bottom plate 68 may be oriented to establish the “base” of the battery array 25 and in which cooling may be effectuated at either one or multiple sides of the battery array 25. For example, referring now to FIGS. 5 and 6, with continued reference to FIGS. 2, 3, and 4, the mounting flanges 74 of the battery array 25 may be mounted to a mounting structure 76 of the traction battery pack 24, such as via one or more mechanical fasteners 84 (e.g., bolts, screws, etc.). The battery array 25 may be oriented such that the bottom plate 68 establishes the “base” of the battery array 25 (see, e.g., FIG. 5). Alternatively, given its symmetrical design, the battery array 25 may be flipped such that the top plate 66 establishes the “base” of the battery array 25 (see, e.g., FIG. 6). The centered mounting flanges 74 may therefore provide increased flexibility when mounting the battery array 25 during assembly of the traction battery pack 24.

The mounting structure 76 depicted in FIGS. 5 and 6 could be any component of the traction battery pack 24. For example, the mounting structure 76 could be a cross-member bracket that is fixedly mounted inside the enclosure assembly 58 of the traction battery pack 24. However, the specific configuration of the mounting structure 76 is not intended to limit this disclosure.

In an embodiment, the mounting structure 76 is integral with or mounted to a heat exchanger plate 82 (sometimes referred to as a “cold plate”) of the traction battery pack 24. The heat exchanger plate 82 could either be a separate component from the enclosure assembly 58 or could be an integrated component of the enclosure assembly 58. In some embodiments, the top plate 66 and the bottom plate 68 may be configured to act as heat exchanger plates.

Since thermal interface material 78, 80 is provided at both the top and the bottom of the battery array 25, the battery array 25 may be cooled from the top, the bottom, or both. FIG. 7 illustrates a configuration in which the battery array 25 may be cooled from the bottom. The battery array 25 may be positioned atop a heat exchanger plate 82 such that the heat exchanger plate 82 is positioned beneath the bottom plate 68. The heat exchanger plate 82 may be part of a liquid cooling system that is associated with the traction battery pack 24 and is configured for thermally managing the battery cells 56 of the battery array 25. For example, heat may be generated and released by the battery cells 56 during charging operations, discharging operations, extreme ambient conditions, or other conditions. The heat may first be conducted to the bottom plate 68, and the heat may subsequently be conducted from the bottom plate 68 to the heat exchanger plate 82. An additional thermal interface material 86 may be disposed between the bottom plate 68 and the heat exchanger plate 82 for facilitating heat transfer. The heat exchanger plate 82 may function as a heat sink for removing heat from the heat sources (e.g., the battery cells 56).

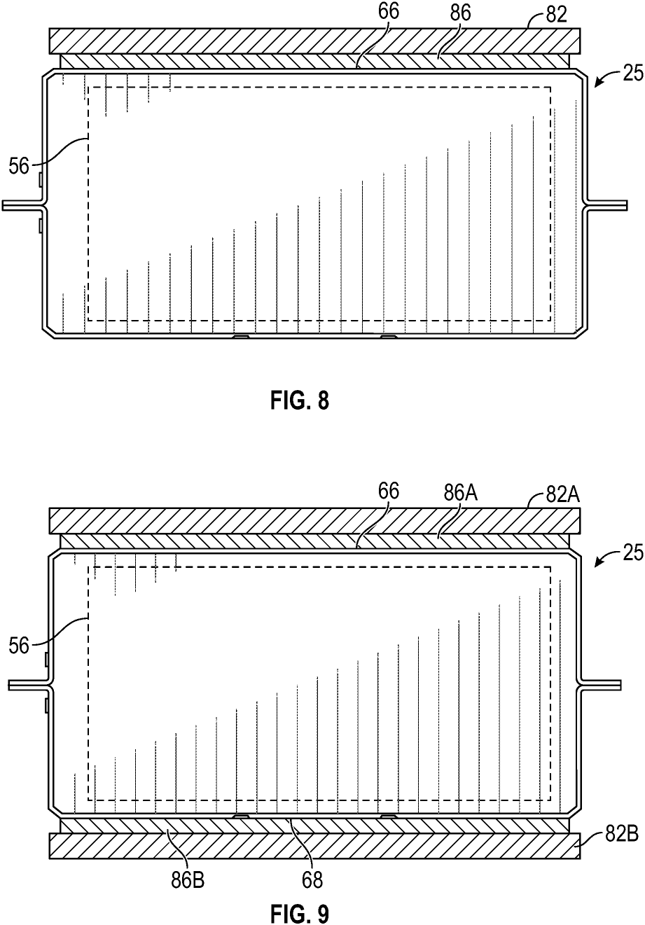

FIG. 8 illustrates a configuration in which the battery array 25 may be cooled from the top. The battery array 25 may be positioned directly beneath a heat exchanger plate 82 such that the heat exchanger plate 82 is positioned over top of the top plate 66. Heat generated and released by the battery cells 56 during charging operations, discharging operations, extreme ambient conditions, or other conditions may first be conducted to the top plate 66, and the heat may then be conducted from the top plate 66 to the heat exchanger plate 82. An additional thermal interface material 86 may be disposed between the top plate 66 and the heat exchanger plate 82 for facilitating the heat transfer.

FIG. 9 illustrates a configuration in which the battery array 25 may be cooled from both the bottom and the top. For example, a first heat exchanger plate 82A may be positioned over top of the battery array 25, and a second heat exchanger plate 82B may be positioned beneath the battery array 25. Heat generated and released by the battery cells 56 during charging operations, discharging operations, extreme ambient conditions, or other conditions may first be conducted to the top plate 66 and the bottom plate 68, and the heat may subsequently be conducted from the top plate 66 to the first heat exchanger plate 82A and from the bottom plate 68 to the second heat exchanger plate 82B. A thermal interface material 86A may be disposed between the top plate 66 and the first heat exchanger plate 82A for facilitating the heat transfer, and another thermal interface material 86B may be disposed between the bottom plate 68 and the second heat exchanger plate 82B for facilitating the heat transfer.

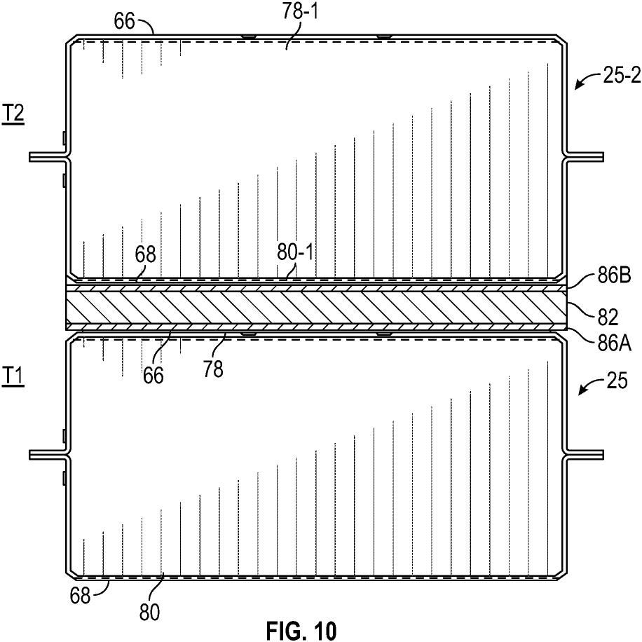

FIG. 10 illustrates a configuration in which the battery array 25 and a second battery array 25-2 are part of a multi-tier configuration of the traction battery pack 24. Arranging battery arrays in tiers may be desirable for packaging reasons and for other design reasons, such as increasing the energy density of the traction battery pack 24, for example. The second battery array 25-2 may include a design that is similar to that of the battery array 25 and therefore likewise may include thermal interface materials 78-2, 80-2 provided at the top and the bottom of the second battery array 25-2.

In this embodiment, the battery array 25 is positioned to establish a first tier T1 of the traction battery pack 24, and the second battery array 25-2 is positioned to establish a second tier T2 of the traction battery pack 24. A heat exchanger plate 82 may be disposed between the battery array 25 and the second battery array 25-2. The battery array 25 and the second battery array 25-2 may therefore be thermally managed by a common heat exchanger plate.

A thermal interface material 86A may be disposed between the top plate 66 of the battery array 25 and the heat exchanger plate 82 for facilitating the heat transfer from the battery array 25, and another thermal interface material 86B may be disposed between the bottom plate 68 of the second battery array 25-2 and the heat exchanger plate 82 for facilitating the heat transfer from the second battery array 25-2. This type of multi-tier cooling arrangement is made possible by utilizing thermal interface materials at multiple sides of the battery arrays 25, 25-2, thereby enabling each battery array 25, 25-2 to be positioned in either the first tier T1 or the second tier T2.

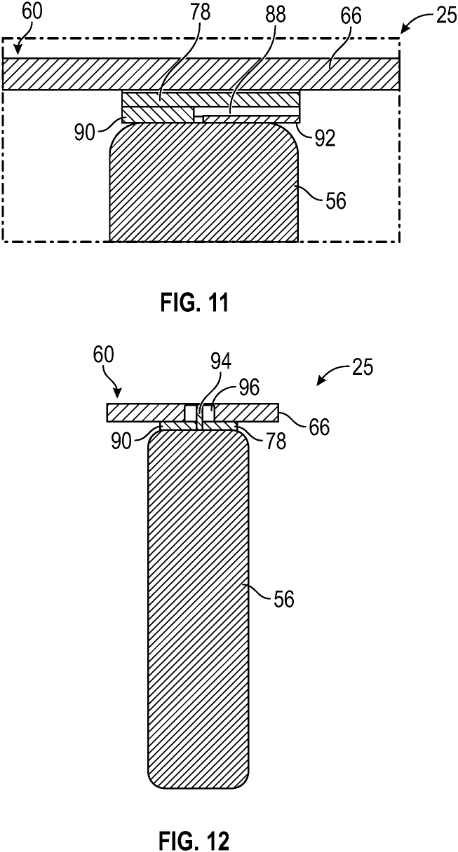

FIG. 11 illustrates additional design aspects that can be incorporated into the battery array 25. In this embodiment, the top plate 66 of the support structure 60 is illustrated with respect to one of the battery cells 56 of the battery array 25. However, the design shown in FIG. 11 could also be utilized with respect to the bottom plate 68 of the battery array 25.

The battery cell 56 may include a bent fold 88 that is positioned between a top surface 90 of the battery cell 56 and the top plate 66. A thermal interface material 78 may be disposed between the top surface 90 and the top plate 66. Furthermore, a thermal adhesive 92 may be disposed between the top surface 90 and the bent fold 88 for improving the thermal conductivity of the battery cell 56 in the void between the bent fold 88 and the top surface 90.

FIG. 12 illustrates additional design aspects that can be incorporated into the battery array 25. In this embodiment, the top plate 66 of the support structure 60 is illustrated with respect to one of the battery cells 56 of the battery array 25. However, the design shown in FIG. 12 could equally apply to the bottom plate 68 of the battery array 25.

The battery cell 56 may include a fold 94. The fold 94 may be at least partially accommodated within a relief opening 96 (e.g. a slot or other hole) that is formed through the top plate 66. Nesting the fold 94 within the relief opening 96 allows the top plate 66 to be positioned closer to the active material of the battery cell 56, thereby helping reduce the vertical Z-axis height of the battery array 25. A thermal interface material 78 may be disposed between a top surface 90 of the battery cell 56 and the top plate 66 for facilitating heat transfer between the battery cell 56 and the top plate 66. The fold 94 may extend through the thermal interface material 78.

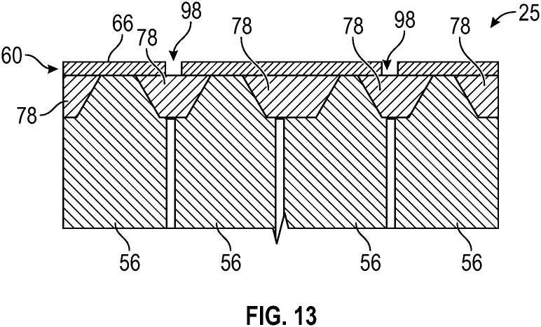

FIG. 13 illustrates additional design aspects that can be incorporated into the battery array 25. In this embodiment, the top plate 66 of the support structure 60 is illustrated with respect to several battery cells 56 of the battery array 25. However, the design shown in FIG. 13 could equally apply to the bottom plate 68 of the battery array 25.

The top plate 66 may include a plurality of fill ports 98. After assembling the battery array 25, a thermal interface material 78 may be injected through the fill ports 98 and into a void between the top plate 66 and the battery cells 56. The fill ports 98 therefore allow for a calculated amount of the thermal interface material 78 to be internally applied within the battery array 25, thereby improving cooling by increasing the amount of battery cell surface area that is in contact with the top plate 66.

The various thermal interface materials described above are shown schematically and thus are not necessarily drawn to scale. In particular, the cross-sectional thickness of each thermal interface material has in many cases been exaggerated to better illustrate the features of this disclosure.

The exemplary traction battery packs of this disclosure incorporate battery arrays having novel features for achieving various advantageous mounting and cooling configurations. Among other benefits, the proposed designs may reduce the number of unique array parts needed to support different array mounting locations, simplify servicing, enable the incorporation of multi-tier structures, and provide increased array cooling capacity for higher performance vehicles.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a top plate;
a bottom plate;
a battery cell arranged between the top plate and the bottom plate;
a first thermal interface material disposed between the top plate and the battery cell; and
a second thermal interface material disposed between the bottom plate and the battery cell.

2. The battery array as recited in claim 1, comprising a side plate connected to both the top plate and the bottom plate.

3. The battery array as recited in claim 2, wherein the side plate includes a mounting flange that is spaced at about an equal distance from both the top plate and the bottom plate.

4. The battery array as recited in claim 3, wherein the battery array is secured to a support structure via the mounting flange.

5. The battery array as recited in claim 4, wherein the support structure is a cross-member bracket of the traction battery pack.

6. The battery array as recited in claim 1, comprising a heat exchanger plate positioned atop the top plate.

7. The battery array as recited in claim 6, comprising a third thermal interface material disposed between the heat exchanger plate and the top plate.

8. The battery array as recited in claim 1, comprising a heat exchanger plate positioned beneath the bottom plate.

9. The battery array as recited in claim 8, comprising a third thermal interface material disposed between the heat exchanger plate and the bottom plate.

10. The battery array as recited in claim 1, comprising a first heat exchanger plate positioned atop the top plate and a second heat exchanger plate positioned beneath the bottom plate.

11. The battery array as recited in claim 10, comprising a third thermal interface material disposed between the first heat exchanger plate and the top plate and a fourth thermal interface material disposed between the second heat exchanger plate and the bottom plate.

12. The battery array as recited in claim 1, comprising a second battery array positioned over top of the top plate to establish a multi-tier configuration, and further comprising a heat exchanger plate disposed between the top plate of the battery array and a second bottom plate of the second battery array.

13. The battery array as recited in claim 1, wherein the battery cell includes a bent fold disposed between the top plate or the bottom plate and a surface of the battery cell, and further comprising a thermal adhesive disposed between the bent fold and the surface.

14. The battery array as recited in claim 1, wherein the battery cell includes a fold accommodated within a relief opening of the top plate or the bottom plate.

15. The battery array as recited in claim 1, wherein the top plate or the bottom plate includes a plurality of fill ports.

16. A battery array for a traction battery pack, comprising:
a grouping of battery cells;
a support structure arranged around an outer perimeter of the grouping of battery cells and including a pair of end plates, a pair of side plates, a top plate, and a bottom plate,
wherein each side plate of the pair of side plates includes a mounting flange that is located at about an equal distance from both the top plate and the bottom plate;
a first thermal interface material disposed between the top plate and the grouping of battery cells; and
a second thermal interface material disposed between the bottom plate and the grouping of battery cells.

17. The battery array as recited in claim 16, wherein the first and second thermal interface materials are applied internally of the support structure.

18. The battery array as recited in claim 16, wherein the mounting flange is secured to a support structure of the traction battery pack.

19. The battery array as recited in claim 16, comprising a heat exchanger plate positioned over the top plate or beneath the bottom plate.

20. The battery array as recited in claim 16, comprising a first heat exchanger plate positioned over the top plate and a second heat exchanger plate positioned beneath the bottom plate.
